(19) United States
(12) Patent Application Publication
(10) Pub. No.: US 2011/0046940 A1
(43) Pub. Date: Feb. 24, 2011

(54) MACHINE TRANSLATION DEVICE, MACHINE TRANSLATION METHOD, AND PROGRAM

(76) Inventors: Rie Tanaka, Tokyo (JP); Toru Ishida, Tokyo (JP); Yohei Murakami, Tokyo (JP)

Correspondence Address: Tomoko Nakajima;Cermak Nakajima LLP, 127 S. Peyton Street, Suite 210, Alexandria, VA, 22314, US

(21) Appl. No.: 12/866,657

(22) PCT Filed: Jan. 15, 2009
(86) PCT No.: PCT/JP2009/050418

§ 371 Date: Oct. 25, 2010

(30) Foreign Application Priority Data
Feb. 13, 2008 (JP) 2008-031188 2008

(51) Int. Cl. G06F 17/28

(52) U.S. Cl. 704/2

(57) ABSTRACT

A machine translation device includes: an accepting portion that accepts a first-language document; storage portion in which are stored one or more pieces of multilingual parallel translation information that are each a set of synonymous words in the first language through the Nth language (N is 3 or more integer); a selecting portion that selects the multilingual parallel translation information including a word included in an ith-language document (i is an integer of 1 to N-1) from the one or more pieces of multilingual parallel translation information; a machine translation portion that repeats processing of machine translating the ith-language document into an (i+1)th language document until machine translation into the Nth language has been performed, so as to use parallel-translation relation between two languages included in the selected multilingual parallel translation information; and an output portion that outputs the Nth-language document.

### TECHNICAL FIELD

The present invention relates to a machine translation device or the like that performs machine translation from a first language through an Nth language (N is an integer of 3 or more) by repeating machine translation between two languages.

### BACKGROUND ART

Conventionally, machine translation devices are known that mechanically translate a document in a source language into a document in a target language, and the accuracy of machine translation performed by such devices has been increasing (for example, see Patent Document 1).

By repeating such machine translation between two languages, it is also possible to realize machine translation between two languages for which machine translation has not been able to be performed. For example, even in the case where Japanese-English machine translation and English-German machine translation are available, but Japanese-German machine translation is not available, it is possible to realize machine translation from Japanese into German by performing Japanese-English machine translation for a Japanese document to obtain an English translation and performing English-German machine translation for the obtained English translation to obtain a German translation.
[Patent Document 1] JP 2008-15844A

### DISCLOSURE OF INVENTION

### Problem to be Solved by the Invention

However, when such machine translation between two languages is repeated, there is the possibility that drift may occur in a translated word due to the ambiguity of words. For example, the Japanese word “ [symbol] (ayamachi)” (which means “mistake”) is machine translated by Japanese-English machine translation into the English word “fault”, and this English word may be translated by English-German machine translation into the German word “Schuld”. This German word “Schuld” means “responsibility”. Accordingly, with this machine translation, the Japanese word “ [symbol] (ayamachi)” is translated into a different meaning, resulting in drift in a translated word. This occurs because the English word “fault” has the meaning “mistake” and the meaning “responsibility”.

As described above, there is the possibility of occurrence of drift in a translated word due to the ambiguity of words in the case of performing machine translation in which translation from a first language through an Nth language (N is an integer of 3 or more) is performed by repeating machine translation between two languages. As a result, the meaning of a document in the first language and the meaning of a translated document in the Nth language document may be different from each other.

The present invention has been achieved in order to solve such a problem, and it is an object of the invention to provide a machine translation device or the like that can suppress the occurrence of drift in a translated word even in the case of performing machine translation in which translation from a first language through an Nth language (N is an integer of 3 or more) is performed by repeating machine translation between two languages.

### Means for Solving the Problems

In order to achieve the above object, a machine translation device according to the present invention is a machine translation device that performs translation from a first language through an Nth language (N is an integer of 3 or more) by repeating machine translation between two languages, the device including: a translation object document accepting portion that accepts a translation object document that is a document in the first language that is to be translated; a multilingual parallel translation information storage portion in which are stored one or more pieces of multilingual parallel translation information that are each a set of synonymous words in the first language through the Nth language; a multilingual parallel translation information selecting portion that selects the multilingual parallel translation information including a word included in a translation object document in an ith language (i is an integer of 1 to N-1) from the one or more pieces of multilingual parallel translation information stored in the multilingual parallel translation information storage portion; a machine translation portion that repeats processing of machine translating the translation object document in the ith language into an (i+1)th language until machine translation into the Nth language has been performed, so as to use parallel-translation relation between two languages included in the multilingual parallel translation information selected by the multilingual parallel translation information selecting portion, starting from the translation object document in the first language that has been accepted by the translation object document accepting portion; and an output portion that outputs a document in the Nth language resulting from machine translation performed by the machine translation portion.

This configuration makes it possible to perform translation from the first language through the Nth language by repeating machine translation between two languages. At the time of such machine translation, it is possible to suppress the occurrence of drift in a translated word by using the multilingual parallel translation information selected by the multilingual parallel translation information selecting portion.

In the machine translation device according to the present invention, the machine translation portion may include: a machine translation unit that repeats processing of machine translating the translation object document in the ith language into an (i+1)th language, starting from the translation object document in the first language that has been accepted by the translation object document accepting portion; a translation result document accumulating unit that accumulates a translation result document that is a document resulting from machine translation performed by the machine translation unit; a translation pair acquisition unit that acquires a translation pair that is a pair formed by a word included in a translation object document and a word included in a translation result document resulting from machine translating the translation object document by the machine translation unit and that have parallel-translation relation; a replacement pair identification unit that identifies a replacement pair that is a pair formed by a replacement object word that is a word in a target language included in, among translation pairs acquired by the translation pair acquisition unit, a translation pair not included in the multilingual parallel translation information selected by the multilingual parallel translation information selecting portion, and a replacement result word that is a word in the target language included in multilingual parallel translation information that includes a word in a source language included in said translation pair and that has been selected by the multilingual parallel translation information selecting portion; and a translation result document modification unit that generates a modified translation result document that is a document in which, among words included in the translation result document accumulated by the translation result document accumulating unit, the replacement object word included in the replacement pair identified by the replacement pair identification unit has been replaced by the replacement result word included in said replacement pair, the machine translation unit may perform machine translation by using the modified translation result document generated by the translation result document modification unit as the translation object document, and the output portion may output the modified translation result document in the Nth language that has been generated by the translation result document modification unit.

This configuration enables a word included in a translation result document to be modified into a word included in the selected multilingual parallel translation information in machine translation using a general-purpose machine translation unit, thus suppressing the occurrence of drift in a translated word.

In the machine translation device according to the present invention, the machine translation portion may further include a bilingual dictionary storage unit in which is stored a bilingual dictionary that is information associating a word in the ith language with a word in the (i+1)th language, and the translation pair acquisition unit may acquire the translation pair by using the bilingual dictionary stored in the bilingual dictionary storage unit.

This configuration enables the translation pair acquisition unit to acquire a translation pair by using the translation object document, the translation result document, and the bilingual dictionary, for example, even if the translation pair acquisition unit cannot receive a translation pair from the machine translation unit.

In the machine translation device according to the present invention, the translation pair acquisition unit may acquire the translation pair from the machine translation unit.

In the machine translation device according to the present invention, the translation pair acquisition unit may acquire the translation pair whose word in a source language is included in the multilingual parallel translation information selected by the multilingual parallel translation information selecting portion.

With this configuration, the translation pair acquisition unit will have a necessary and sufficient volume of translation pairs, thus avoiding acquisition of an excess translation pair. As a result, it is possible to reduce the recording area in which translation pairs are held.

In the machine translation device according to the present invention, the multilingual parallel translation information selecting portion may select multilingual parallel translation information from the multilingual parallel translation information resulting from the previous selection, each time machine translation between two languages is performed.

With this configuration, the multilingual parallel translation information can be narrowed down each time machine translation between two languages is performed, and therefore the later the stage of machine translation between two languages, the faster the translation processing can be performed.

### Effect of the Invention

With the machine translation device or the like according to the present invention, it is possible to suppress the occurrence of drift in a translated word even in the case of performing machine translation in which translation from a first language through an Nth language (N is an integer of 3 or more) is performed by repeating machine translation between two languages.

### BEST MODE FOR CARRYING OUT THE INVENTION

Hereinafter, a machine translation device of the present invention will be described by way of an embodiment. In the following embodiment, those components and steps that are denoted by the same reference numerals are the same or corresponding components and steps, and any redundant description thereof may be omitted.

### Embodiment 1

A machine translation device according to Embodiment 1 of the present invention will be described with reference to the drawings. The machine translation device according to this embodiment performs machine translation from a first through an Nth language (N is an integer of 3 or more) by repeating machine translation between two languages.

FIG. 1 is a block diagram showing a configuration of a machine translation device 1 according to this embodiment. The machine translation device 1 of this embodiment includes a translation object document accepting portion 11, a multilingual parallel translation information storage portion 12, a multilingual parallel translation information selecting portion 13, a machine translation portion 14, and an output portion 15.

The translation object document accepting portion 11 accepts a translation object document that is a document in the first language that is to be translated. The translation object document may be a document including, for example, a single sentence or multiple sentences, or a part of a sentence (for example, a phrase or the like). The translation object document may be any data from which a translation object can be identified, including, for example, text data.

For example, the translation object document accepting portion 11 may accept a translation object document that has been input from an input device (for example, a keyboard, a mouse, or a touch panel), receive a translation object document transmitted via a wired or wireless communications line, or accept a translation object document read from a specific recording medium (for example, an optical disk, a magnetic disk, or a semiconductor memory). Note that the translation object document accepting portion 11 may or may not include a device (for example, a modem or a network card) for performing acceptance. In addition, the translation object document accepting portion 11 may be implemented with hardware, or may be implemented with software such as a driver for driving a specific device.

In the multilingual parallel translation information storage portion 12, one or more pieces of multilingual parallel translation information that are each a set of synonymous words in the first language through the Nth language are stored. Thus, the multilingual parallel translation information includes a word in the first language, a word in the second language, . . . , a word in the (N-1)th language, and a word in the Nth language that are synonymous words. The multilingual parallel translation information may be information including, for example, the Japanese word “ [symbol] (sora)”, the English word “sky”, and the German word “Himmel”. Here, a word is a unit constituting a sentence, and may be, for example, a word or a morpheme in a grammatical sense, or may be a short sequence of words (idiom) in a grammatical sense. There is no limitation with respect to the method for generating this multilingual parallel translation information. For example, the multilingual parallel translation information may be generated manually or mechanically. Preferably, the number of pieces of multilingual parallel translation information stored in the multilingual parallel translation information storage portion 12 is two or more. This is because when a larger number of pieces of multilingual parallel translation information are stored, the range of the selection (described below) performed by the multilingual parallel translation information selecting portion 13 is wider, which is preferable. This embodiment describes mainly the case where two or more pieces of multilingual parallel translation information are stored in the multilingual parallel translation information storage portion 12.

There is no limitation with respect to the process in which one or more pieces of multilingual parallel translation information are stored in the multilingual parallel translation information storage portion 12. For example, one or more pieces of multilingual parallel translation information may be stored via a recording medium in the multilingual parallel translation information storage portion 12, or one or more pieces of multilingual parallel translation information transmitted via a communications line or the like may be stored in the multilingual parallel translation information storage portion 12. Alternatively, one or more pieces of multilingual parallel translation information that have been input via an input device may be stored in the multilingual parallel translation information storage portion 12. Storage in the multilingual parallel translation information storage portion 12 may be temporary storage in a RAM or the like, or may be long-term storage. The multilingual parallel translation information storage portion 12 may be implemented with a specific recording medium (for example, a semiconductor memory, a magnetic disk, or an optical disk).

The multilingual parallel translation information selecting portion 13 selects the multilingual parallel translation information including a word included in the translation object document in an ith language (i is an integer of 1 to N-1) from the one or more pieces of multilingual parallel translation information stored in the multilingual parallel translation information storage portion 12. When the selection is made from a single piece of multilingual parallel translation information, the processing is performed for determining whether to adopt the single piece of multilingual parallel translation information. As described above, it is preferable that the selection is made from a larger number of pieces of multilingual parallel translation information. The multilingual parallel translation information selecting portion 13 selects multilingual parallel translation information from the multilingual parallel translation information resulting from the previous selection, each time machine translation between two languages is performed. Accordingly, each time a translation object document in the ith language is translated into a document in the (i+1)th language, this selection by the multilingual parallel translation information selecting portion 13 is performed. As described above, the multilingual parallel translation information is a set of words in the first language through the Nth language, and the multilingual parallel translation information selecting portion 13 selects multilingual parallel translation information including a word in the ith language that is included in a translation object document in the ith language. Accordingly, each time machine translation between two languages is repeated, the selected multilingual parallel translation information is narrowed down.

The multilingual parallel translation information selecting portion 13 may temporarily store the selected multilingual parallel translation information in a recording medium (not shown), or may be configured to be able to identify the selected multilingual parallel translation information by adding a flag or the like to selected ones of the multilingual parallel translation information stored in the multilingual parallel translation information storage portion 12. Thus, there is no limitation with respect to the method for indicating selected multilingual parallel translation information, as long as the selected multilingual parallel translation information can be identified.

The machine translation portion 14 repeats processing of machine translating the translation object document in the ith language into an (i+1)th language so as to use parallel-translation relation between two languages included in the multilingual parallel translation information selected by the multilingual parallel translation information selecting portion, starting from the translation object document in the first language that has been accepted by the translation object document accepting portion. The phrase “machine translating . . . until machine translation into the Nth language has been performed, so as to use parallel-translation relation between two languages included in the multilingual parallel translation information selected by the multilingual parallel translation information selecting portion 13” means, for example, that machine translation is performed such that if a word included in a translation object document in the ith language is included in the selected multilingual parallel translation information when the machine translation portion 14 performs machine translation from the ith language into the (i+1)th language, then that word is translated into a word in the (i+1)th language that is included in that selected multilingual parallel translation information.

The machine translation portion 14 may be configured to perform such machine translation by loading the selected multilingual parallel translation information and altering the machine translation mechanism itself, or by using conventional machine translation and modifying a result obtained by that machine translation by using the selected multilingual parallel translation information. This embodiment describes the latter case. In the latter case, the machine translation portion 14 includes a machine translation unit 21, a translation result document accumulating unit 22, a bilingual dictionary storage unit 23, a translation pair acquisition unit 24, a replacement pair identification unit 25, and a translation result document modification unit 26 as shown in FIG. 1.

The machine translation unit 21 repeatedly performs processing of machine translating the translation object document in the ith language into an (i+1)th language, starting from the translation object document in the first language that has been accepted by the translation object document accepting portion 11. This machine translation unit 21 performs machine translation from the ith language through the (i+1)th language for all the cases where i is from 1 to (N-1), and uses conventional machine translation for its machine translation mechanism. Accordingly, the machine translation unit 21 performs machine translation without consideration given to the selected multilingual parallel translation information. For example, when the machine translation portion 14 performs machine translation from Japanese into English and machine translation from English into German, the machine translation unit 21 performs Japanese-English machine translation and English-German machine translation. The machine translation unit 21 machine translates, as a translation object document, a modified translation result document generated by the translation result document modification unit 26, which will be described later. A document for which the machine translation unit 21 performs machine translation is referred to as a “translation object document”, and a document resulting from machine translation performed by the machine translation unit 21 is referred to as a “translation result document”.

The translation result document accumulating unit 22 accumulates a translation result document resulting from machine translation performed by the machine translation unit 21 in a recording medium (not shown). This recording medium is, for example, a semiconductor memory, an optical disk, a magnetic disk, or the like, and may be included in the translation result document accumulating unit 22, or may exist outside the translation result document accumulating unit 22. In addition, this recording medium may or may not temporarily store a translation result document.

A bilingual dictionary that is information associating a word in the ith language with a word in the (i+1)th language is stored in the bilingual dictionary storage unit 23 for all the cases where i is 1 to (N-1). This bilingual dictionary is information associating words in two languages having parallel-translation relation.

The phrase “associating words in two languages” means that one word in a given language and another word in a different language can each be acquired from the other word. Accordingly, the bilingual dictionary may include information including a word in a given language and a word in a different language as a set, or may be information linking a word in a given language to a word in a different language. In the latter case, the bilingual dictionary may be, for example, information associating pointers or addresses indicating the locations where a word in a given language and a word in a different language are stored. This embodiment describes the former case.

In addition, it is preferable that, for words having parallel-translation relation, one or more words in a target language are associated with a word in a source language in the bilingual dictionary. That is, the bilingual dictionary may include, for example, a set including the word “ [symbol] (sora)” in Japanese, which is a source language, and the words “sky, air, heaven” in English, which is a target language.

For example, when the machine translation portion 14 performs machine translation from Japanese into English and machine translation from English into German, a Japanese-English bilingual dictionary and an English-German bilingual dictionary are stored in the bilingual dictionary storage unit 23. Thus, multiple types of bilingual dictionaries are stored in the bilingual dictionary storage unit 23.

There is no limitation with respect to the process in which multiple types of bilingual dictionaries are stored in the bilingual dictionary storage unit 23. For example, multiple types of bilingual dictionaries may be stored via a recording medium in the bilingual dictionary storage unit 23, or multiple types of bilingual dictionaries transmitted via a communications line or the like may be stored in the bilingual dictionary storage unit 23. Alternatively, multiple types of bilingual dictionaries that have been input via an input device may be stored in the bilingual dictionary storage unit 23. Storage in the bilingual dictionary storage unit 23 may be temporary storage in a RAM, for example, or may be long-term storage. The bilingual dictionary storage unit 23 may be implemented with a specific recording medium (for example, a semiconductor memory, a magnetic disk, or an optical disk).

The translation pair acquisition unit 24 acquires a translation pair. Here, a translation pair is a pair formed by a word included in a translation object document and a word included in a translation result document resulting from machine translation performed for that translation object document by the machine translation unit 21. The words forming a pair that are included in the translation pair is a pair of words having parallel-translation relation. The translation pair acquisition unit 24 may acquire a translation pair from the machine translation unit 21, or may acquire a translation pair by using a bilingual dictionary stored in the bilingual dictionary storage unit 23. Ordinarily, during machine translation, the machine translation unit 21 is able to identify a word in the source language word and a word in the target language resulting from translation of that source language word. Accordingly, in the former case, the translation pair acquisition unit 24 acquires a translation pair that is a pair formed by the source language word and the target language word. On the other hand, when a translation pair cannot be acquired from the machine translation unit 21, the translation pair acquisition unit 24 acquires a translation pair by using a bilingual dictionary, as in the latter case. This embodiment describes the latter case, that is, the case where the translation pair acquisition unit 24 acquires a translation pair by using a bilingual dictionary.

Specifically, when a word resulting from translation of a word included in a translation object document in the ith language into a word in the (i+1)th language by using a bilingual dictionary for the ith language and the (i+1)th language is included in a translation result document in the (i+1)th language, the translation pair acquisition unit 24 acquires a translation pair that is a pair formed by the word included in the ith language translation object document and the word resulting from translation of the ith language word into the (i+1)th language by using the bilingual dictionary.

Also, the translation pair acquisition unit 24 may acquire a translation pair including a source language word included in the multilingual parallel translation information selected by the multilingual parallel translation information selecting portion 13. Here, the translation pair is a pair formed by a word in the ith language and a word in the (i+1)th language. Of these words, the ith language is referred to as a source language and the (i+1)th language is referred to as a target language. When the translation pair acquisition unit 24 acquires a translation pair including a word in the source language that is included in the selected multilingual parallel translation information, the translation pair acquisition unit 24 may, for example, acquire translation pairs in the above-described manner, then determining whether the source language word included in each of the acquired translation pairs is included in the selected multilingual parallel translation information, and leaving those translation pairs that include a source language word included in the selected multilingual parallel translation information, while discarding (determining as not being a translation pair) those translation pairs that include a source language word that is not included in the selected multilingual parallel translation information.

Also, the translation pair acquisition unit 24 may acquire a translation pair that is a pair of words belonging to a specific part of speech. For example, the translation pair acquisition unit 24 may acquire a translation pair that is a pair of nouns when nouns are included in the multilingual parallel translation information, may acquire a translation pair that is a pair of independent words when independent words are included in the multilingual parallel translation information, or may acquire a translation pair that is a pair of words belonging to a part of speech that matches the part of speech of the words included in the multilingual parallel translation information. The reason is that, even if a translation pair that is a pair of words belonging to a part of speech that is not included in the multilingual parallel translation information is acquired, such a translation pair will not be used in a later process. In addition, in the case of acquiring only a translation pair belonging to a specific part of speech, the translation pair acquisition unit 24 may, for example, analyze the part of speech of each word by performing morphological analysis or the like for the translation object document, and perform the processing of acquiring a translation pair only for the words belonging to the specific part of speech by using the results of that analysis. The methods for analyzing the part of speech of each word, including, for example, morphological analysis, are known, and therefore, the detailed description thereof has been omitted.

For Japanese, for example, “ChaSen” (http://chasen.naist.jp), which has been developed at Nara Institute of Science and Technology, and the like are known as morphological analysis systems. For English, for example, “TnT” (http://www.coli.uni-saarland.de/˜thorsten/tnt/) and “Brill Tagger” (http://www.cs.jhu.edu/˜brill/) are known as software for providing an English word with a part of speech. As for the Brill software, please see the following document, for example.

Document: Eric Brill, “Transformation-Based Error-Driven Learning and Natural Language Processing: A Case Study in Part-of-Speech Tagging”, Computational Linguistics, Vol. 21, No. 4, p. 543-565, 1995.

When a word having parallel-translation relation with the source language word included in the translation object document cannot be found in the translation result document during acquisition of a translation pair using the bilingual dictionary, the translation pair acquisition unit 24 may identify a word having parallel-translation relation with the source language word of the translation result document by using a result obtained by machine translating that source language word by the machine translation unit 21. Specifically, if a target language word resulting from machine translating a given source language word by the machine translation unit 21 is included in a translation result document, then the translation pair acquisition unit 24 may acquire a translation pair including, as a pair, the source language word and a target language word resulting from machine translation of that source language word.

The translation pair acquisition unit 24 may temporarily store the acquired translation pair in a recording medium (not shown), or may be configured to be able to identify a translation pair by adding a flag or the like to the words corresponding to the acquired translation pair in the information included in the bilingual dictionary stored in the bilingual dictionary storage unit 23. Thus, there is no limitation with respect to the method for indicating a translation pair, as long as the translation pair can be identified.

The replacement pair identification unit 25 identifies a replacement pair. This replacement pair is a pair formed by a replacement object word and a replacement result word. A replacement object word is a word in a target language included in, among the translation pairs acquired by the translation pair acquisition unit 24, a translation pair not included in the multilingual parallel translation information selected by the multilingual parallel translation information selecting portion 13. The “translation pair not included in the multilingual parallel translation information selected by the multilingual parallel translation information selecting portion 13” is a translation pair including both a source language word and a target language word that are not included in the selected multilingual parallel translation information. A replacement result word is a word in the target language (the target language of a translation pair not included in any selected multilingual parallel translation information) included in the selected multilingual parallel translation information including a word in a source language included in the translation pair not included in any selected multilingual parallel translation information. Here, when there is a single translation pair not included in any selected multilingual parallel translation information, there are cases where the replacement pair can be identified, and where it cannot be identified. The latter case includes a case where there is no selected multilingual parallel translation information including a source language word included in a translation pair not included in any selected multilingual parallel translation information. If only a translation pair including a source language word included in selected multilingual parallel translation information is acquired during acquisition of a translation pair, then there will be no case where the replacement pair cannot be identified. In addition, the case where the replacement pair can be identified includes cases where only a single replacement pair can be identified, and where two or more replacement pairs can be identified. In the latter case, two or more replacement pairs may be identified, or only a single replacement pair selected from those two or more replacement pairs may be identified. This embodiment describes the case where the replacement pair identification unit 25 identifies only a single replacement pair.

The following describes a method by which the replacement pair identification unit 25 identifies only a single replacement pair selected from two or more replacement pairs.

Method Using Word Occurrence Frequency

When there are multiple replacement result words that may correspond to the same replacement object word, the replacement pair identification unit 25 may identify a replacement pair including the replacement result word having the highest frequency of occurrence among the multiple replacement result words. For example, the replacement pair identification unit 25 may acquire the frequency of occurrence of a word by using information that has been stored in advance in a recording medium (not shown) and that includes a word and information indicating the frequency of occurrence of that word in association with each other. For example, such a frequency of occurrence of a word may be calculated by using a specific corpus, or may be calculated by using a document in the (i+1)th language that has been previously machine translated.

Method Using Priority of Context Information

When there are multiple replacement result words that may correspond to the same replacement object word, the replacement pair identification unit 25 may use the context information of a sentence before the translation object document or the entire document to identify a replacement pair that is closer to that context. For example, a context indicating which replacement result word has replaced the replacement object word can be acquired by using information that has been stored in advance in a recording medium (not shown) and that includes a translation object document that was input in the past by the same user and the replacement pair used in association with each other. The context of the entire document can also be acquired by using the theme of the entire document that is stored in advance in a recording medium (not shown). In this case, for example, information including a word and a theme in association with each other may be used to select a word corresponding to the theme of the document, and a replacement pair including the selected word can be identified. For example, when the theme of the document is “economy”, the word “ [symbol] (ginko)” (which means “bank” (place where money is kept)) may be selected as a replacement result word from the replacement result word candidates: the words “ [symbol] (dote)” (which means “bank (embankment)”) and “ [symbol] (ginko)”. In this case, for example, the theme “nature” corresponds to the word “ [symbol] (dote)”, and the theme “economy” corresponds to the word “ [symbol] (ginko)”.

Other Methods

When there are multiple replacement result words that may correspond to the same replacement object word, the replacement pair identification unit 25 may identify a replacement pair including a replacement result word randomly selected from the multiple replacement result words. Alternatively, when there are multiple replacement result words that may correspond to the same replacement object word, the replacement pair identification unit 25 may identify a replacement pair including a predetermined one of the multiple replacement result words, such as the first replacement result word.

Note that the method for identifying a replacement pair is not limited to the above-described methods, and a replacement pair may be identified by a method other than these methods.

The replacement pair identification unit 25 may temporarily store the identified replacement pair in a recording medium (not shown), or may be configured to be able to identify a replacement pair by adding a flag or the like to the words corresponding to the identified replacement pair in other information. Thus, there is no limitation with respect to the method for indicating a replacement pair, as long as the replacement pair can be identified.

The translation result document modification unit 26 generates a modified translation result document from the translation result documents accumulated by the translation result document accumulating unit 22. That is, the translation result document modification unit 26 generates a modified translation result document that is a document in which a replacement object word that is included in the words included in the translation result document and that is included in a replacement pair identified by the replacement pair identification unit 25 has been replaced by the replacement result word included in that replacement pair. When there are two or more replacement pairs including the same replacement object word, the translation result document modification unit 26 may select one of the two or more replacement pairs, and generate a modified translation result document by using the selected replacement pair.

Note that the modified translation result document may be stored in the recording medium in which the translation result document accumulating unit 22 accumulates translation result documents, or may be stored in another recording medium. As described above, the modified translation result document will be used as a translation object document by the machine translation unit 21.

In addition, when the translation result document does not include the replacement object word included in the replacement pair, that is, when the translation result document does not have any portion that needs to be modified, the translation result document will be directly used as a modified translation result document generated by the translation result document modification unit 26.

The output portion 15 outputs a document in the Nth language resulting from machine translation performed by the machine translation portion 14. More specifically, the output portion 15 outputs a modified translation result document in the Nth language generated by the translation result document modification unit 26.

Here, this output may be, for example, output to a display device (for example, a CRT, a liquid crystal display, or the like), transmission to a specific device via a communications line, printing using a printer, audio output using a speaker, accumulation in a recording medium, or transfer to another component. The output portion 15 may or may not include a device for performing output (for example, a display device or a printer). The output portion 15 may be implemented with hardware, or may be implemented with software such as a driver for driving the above-mentioned devices.

Of the multilingual parallel translation information storage portion 12, the recording medium in which translation result documents are accumulated by the translation result document accumulating unit 22, the bilingual dictionary storage unit 23, and the recording medium in which other various pieces of information are stored, any two or more storage portions or recording media may be implemented with the same recording medium, or may be implemented with separate recording media. In the former case, the area in which the multilingual parallel translation information is stored serves as the multilingual parallel translation information storage portion 12, and the area in which the bilingual dictionary is stored serves as the bilingual dictionary storage unit 23, for example.

In the following, an operation of the machine translation device 1 according to this embodiment will be described with reference to the flowchart shown in FIG. 2.

(Step S101) The translation object document accepting portion 11 determines whether a translation object document in the first language has been received. If it has been received, the procedure moves to Step S102; otherwise, the processing of Step S101 is repeated until a translation object document in the first language has been received.

(Step S102) The machine translation portion 14 sets a counter i to 1.

(Step S103) The multilingual parallel translation information selecting portion 13 selects multilingual parallel translation information including a word included in a translation object document in the ith language that is to be machine translated by the machine translation portion 14. When selection of multilingual parallel translation information has been made prior to this selection process, selection is made from the selected multilingual parallel translation information.

Specifically, the multilingual parallel translation information selecting portion 13 may search for multilingual parallel translation information by using each of the words in the ith language translation object document, and select the multilingual parallel translation information found by that search. Alternatively, the multilingual parallel translation information selecting portion 13 may search a translation object document in the ith language by using a word in the ith language that is included in each multilingual parallel translation information, and select the multilingual parallel translation information found by that search and including the ith language word.

(Step S104) The machine translation portion 14 performs machine translation from the ith language translation object document into a document in the (i+1)th language by using the multilingual parallel translation information selected in Step S103 by the multilingual parallel translation information selecting portion 13. The details of this processing will be described later with reference to the flowchart shown in FIG. 3.

(Step S105) The machine translation portion 14 increments the counter i by 1.

(Step S106) The machine translation portion 14 determines whether the counter i is equal to N. Here, it is assumed that N is a pre-set integer of 3 or more, and has been stored in a recording medium (not shown). If the counter i is equal to N, this means that the translation object document has been translated into the Nth language. If the counter i is equal to N, the procedure then moves to Step S107; otherwise, the procedure returns to Step S103.

(Step S107) The output portion 15 outputs a translated document in the Nth language. Then, the procedure returns to Step S101.

In the flowchart shown in FIG. 2, the determination of whether the counter i is equal to N may not be performed in Step S106. This determination may be made in any manner, as long as whether to end a series of machine translation performed by the machine translation portion 14 is determined; for example, it is possible to perform the processing of determining whether a document resulting from machine translation performed by the machine translation portion 14 is a document in the Nth language. In that case, if the machine-translated document is a document in the Nth language, the procedure moves to Step S107; otherwise, the procedure returns to Step S103. In the flowchart shown in FIG. 2, the processing ends by powering off or interruption for aborting the processing.

FIG. 3 is a flowchart showing the details of the machine translation processing using selected multilingual parallel translation information (the processing of Step S104) in the flowchart shown in FIG. 2.

(Step S201) The machine translation unit 21 translates a translation object document in the ith language into a document in the (i+1)th language. The document resulting from this translation is the translation result document.

(Step S202) The translation result document accumulating unit 22 accumulates the translation result document in a recording medium.

(Step S203) The translation pair acquisition unit 24 acquires a translation pair by using the ith language translation object document and the translation result document in the (i+1)th language. The details of this processing will be described later with reference to the flowchart shown in FIG. 4.

(Step S204) From the translation pair acquired by the translation pair acquisition unit 24, the replacement pair identification unit 25 generates a correct pair whose target language word is included in the selected multilingual parallel translation information. When both of the words included in the translation pair are included in the selected multilingual parallel translation information, the replacement pair identification unit 25 directly uses that translation pair as a correct pair. The details of this processing will be described later with reference to the flowchart shown in FIG. 5. The correct pair is a pair formed by a word in the ith language and a word in the (i+1)th language. Of these, the ith language word is referred to as a source language, and the (i+1)th language is referred to as a target language, as with a translation pair.

(Step S205) The replacement pair identification unit 25 identifies a replacement pair by using the translation pair and the correct pair. The details of this processing will be described later with reference to the flowchart shown in FIG. 6.

(Step S206) The translation result document modification unit 26 modifies the translation result document by using the replacement pair identified by the replacement pair identification unit 25, thereby generating a modified translation result document. Then, the procedure returns to the flowchart shown in FIG. 2. The details of this processing will be described later with reference to the flowchart shown in FIG. 7.

FIG. 4 is a flowchart showing the details of the processing of acquiring a translation pair (the processing of Step S203) in the flowchart shown in FIG. 3.

(Step S301) The translation pair acquisition unit 24 sets a counter m to 1.

(Step S302) The translation pair acquisition unit 24 identifies the mth word of the ith language translation object document. To identify this word, morphological analysis may be performed for the ith language translation object document by the translation pair acquisition unit 24 or another component. The reason is that, unlike in an English document and the like, word breaks are not clear in a Japanese document and the like. The same applies to the cases where the word identification or the like is performed in documents in other languages. The identified mth word may be temporarily held in a recording medium (not shown) or the like, or a flag or the like may be added to the identified word in the ith language translation object document.

(Step S303) The translation pair acquisition unit 24 determines whether the mth word identified in Step S302 is included in any selected multilingual parallel translation information. This determination may be made, for example, by sequentially determining whether the identified mth word is included in each selected multilingual parallel translation information. If it is included, the procedure moves to Step S304; otherwise, the procedure moves to Step S310.

(Step S304) The translation pair acquisition unit 24 identifies one or more words in the (i+1)th language that have parallel-translation relation with the identified mth word by using a bilingual dictionary that associates the ith language words with the (i+1)th language words and that is stored in the bilingual dictionary storage unit 23. The identified one or more (i+1)th language words may be temporarily held in a recording medium (not shown) or the like, or a flag or the like may be added to the identified words in the bilingual dictionary.

(Step S305) The translation pair acquisition unit 24 sets the counter n to 1.

(Step S306) The translation pair acquisition unit 24 determines whether the nth word in the (i+1)th language that has been identified in Step S304 is included in the (i+1)th language translation result document resulting from machine translation performed by the machine translation unit 21. If it is included, the procedure moves to Step S309; otherwise, the procedure moves to Step S307.

(Step S307) The translation pair acquisition unit 24 increments the counter n by 1.

(Step S308) The translation pair acquisition unit 24 determines whether the nth word exists among the (i+1)th language words identified in Step S304. If it exists, the procedure returns to Step S306; otherwise, the procedure moves to Step S310.

(Step S309) The translation pair acquisition unit 24 acquires the translation pair including the mth word of the ith language translation object document and the nth word of the words in the (i+1)th language that have been identified in Step S304 as a pair. This translation pair may be temporarily held in a recording medium (not shown) or the like, or a flag or the like may be added to the words included in that translation pair in the translation object document and the translation result document.

(Step S310) The translation pair acquisition unit 24 increments the counter m by 1.

(Step S311) The translation pair acquisition unit 24 determines whether the mth word exists in the ith language translation object document. If it exists, the procedure then returns to Step S302; otherwise, the procedure returns to the flowchart shown in FIG. 3.

FIG. 5 is a flowchart showing the details of the processing of generating a correct pair (the processing of Step S204) in the flowchart shown in FIG. 3.

(Step S401) The replacement pair identification unit 25 sets the counter m to 1.

(Step S402) The replacement pair identification unit 25 determines whether the mth translation pair of the translation pairs acquired by the translation pair acquisition unit 24 is included in any selected multilingual parallel translation information. If it is included, the procedure moves to Step S405; otherwise, the procedure moves to Step S403.

(Step S403) The replacement pair identification unit 25 identifies selected multilingual parallel translation information including the source language word of the mth translation pair, and identifies a word that is included the identified selected multilingual parallel translation information and that is the same language as the target language of the mth translation pair. When there are multiple pieces of selected multilingual parallel translation information including the source language word of the mth translation pair, the replacement pair identification unit 25 selects any one of the multiple pieces of multilingual parallel translation information and performs the word identification, as described above. If there is no selected multilingual parallel translation information including the source language word of the mth translation pair, the procedure may move to Step S406.

(Step S404) The replacement pair identification unit 25 generates a correct pair in which the target language word of the mth translation pair has been replaced by the word identified in Step S403. This correct pair may be temporarily held in a recording medium (not shown) or the like, or a flag or the like may be added to the words included in the correct pair in the translation object document or the selected multilingual parallel translation information.

(Step S405) The replacement pair identification unit 25 uses the mth translation pair as a correct pair. This correct pair may be temporarily held in a recording medium (not shown) or the like, or a flag or the like may be added to the words included in the correct pair in the translation object document or the selected multilingual parallel translation information.

(Step S406) The replacement pair identification unit 25 increments the counter m by 1.

(Step S407) The replacement pair identification unit 25 determines whether the mth translation pair is included in the translation pairs acquired by the translation pair acquisition unit 24. If it is included, the procedure returns to Step S402; otherwise, the procedure returns to the flowchart shown in FIG. 3.

FIG. 6 is a flowchart showing the details of the processing of generating a replacement pair (the processing of Step S205) in the flowchart shown in FIG. 3.

(Step S501) The replacement pair identification unit 25 sets the counter m to 1.

(Step S502) The replacement pair identification unit 25 determines whether the mth translation pair of the translation pairs acquired by the translation pair acquisition unit 24 is included in a set of the correct pairs. For example, if the mth translation pair matches any of the correct pairs, the replacement pair identification unit 25 may determine that the mth translation pair is included in the set of correct pairs. If the mth translation pair is included, the procedure moves to Step S508; otherwise, the procedure moves to Step S503.

(Step S503) The replacement pair identification unit 25 sets the counter n to 1.

(Step S504) The replacement pair identification unit 25 determines whether the source language word included in the mth translation pair matches the source language word included in the nth correct pair. If it matches, the procedure moves to Step S507; otherwise, the procedure moves to Step S505.

(Step S505) The replacement pair identification unit 25 increments the counter n by 1.

(Step S506) The replacement pair identification unit 25 determines whether the nth correct pair exists among the correct pairs generated in the flowchart shown in FIG. 5. If it exists, the procedure returns to Step S504; otherwise, the procedure moves to Step S508.

(Step S507) The replacement pair identification unit 25 identifies a replacement pair including a replacement object word in the target language of the mth translation pair and a replacement result word in the target language of the nth correct pair. This replacement pair may be temporarily held in a recording medium (not shown) or the like, or a flag or the like may be added to the words included in the replacement pair in the translation result document or the selected multilingual parallel translation information.

(Step S508) The replacement pair identification unit 25 increments the counter m by 1.

(Step S509) The replacement pair identification unit 25 determines whether the mth translation pair is included in the translation pairs acquired by the translation pair acquisition unit 24. If it is included, the procedure returns to Step S502; otherwise, the procedure returns to FIG. 3.

FIG. 7 is a flowchart showing the details of the processing of modifying a translation result document (the processing of Step S206) in the flowchart shown in FIG. 3.

(Step S601) The translation result document modification unit 26 sets the counter m to 1.

(Step S602) The translation result document modification unit 26 identifies the mth word of the (i+1)th language translation result document accumulated by the translation result document accumulating unit 22. This identified mth word may be temporarily held in a recording medium (not shown) or the like, or a flag or the like may be added to the identified word in the (i+1)th language translation result document.

(Step S603) The translation result document modification unit 26 sets the counter n to 1.

(Step S604) The translation result document modification unit 26 determines whether the mth word of the (i+1)th language translation result document that has been identified in Step S602 and the replacement object word included in the nth replacement pair match. If they match, the procedure moves to Step S607; otherwise, the procedure moves to Step S605.

(Step S605) The translation result document modification unit 26 increments the counter n by 1.

(Step S606) The translation result document modification unit 26 determines whether the nth replacement pair exists. If it exists, the procedure returns to Step S604; otherwise, the procedure moves to Step S608.

(Step S607) The translation result document modification unit 26 replaces the mth word of the (i+1)th language translation result document that has been identified in Step S602 by the replacement result word included in the nth replacement pair in the (i+1)th language translation result document.

(Step S608) The translation result document modification unit 26 increments the counter m by 1.

(Step S609) The translation result document modification unit 26 determines whether the mth word exists in the (i+1)th language translation result document. If it exists, the procedure returns to Step S602; otherwise, the procedure returns to the flowchart shown in FIG. 3. Note that the (i+1)th language translation result document for which a series of processing in FIG. 7 has been completed, that is, the (i+1)th language translation result document for which an appropriate word replacement has been carried out will be a modified translation result document.

In the following, an operation of the machine translation device 1 according to this embodiment will be described by way of a specific example. In this specific example, a description is given of the case where the machine translation device 1 translates a Japanese translation object document into German by performing Japanese-English translation and English-German translation. Accordingly, the machine translation device 1 performs machine translation from a first language through a third language, and therefore N is set to 3.

In this specific example, it is assumed that multilingual parallel translation information that is a set of a Japanese word, an English word, and a German word that are synonymous with each other is stored in the multilingual parallel translation information storage portion 12. FIG. 8 is a table showing examples of the multilingual parallel translation information used in this specific example. In FIG. 8, each record is multilingual parallel translation information including a Japanese word, an English word, and a German word. For example, the first multilingual parallel translation information includes the Japanese word “ [symbol] (sora)”, the English word “sky”, and the German word “Himmel”.

Further, in this specific example, it is assumed that a Japanese-English bilingual dictionary and an English-German bilingual dictionary are stored in the bilingual dictionary storage unit 23. FIG. 9 is a table showing an example of the Japanese-English bilingual dictionary used in this specific example. As shown in FIG. 9, the Japanese-English bilingual dictionary is information including multiple sets of a source language word and target language words. For example, the source language (Japanese) word “ [symbol] (sora)” is associated with the target language (English) words “sky, air, heaven”. Accordingly, using this Japanese-English bilingual dictionary makes it possible to acquire, from the Japanese word “ [symbol] (sora)”, the English words “sky”, “air”, and “heaven” that have parallel-translation relation with “ [symbol] (sora)”.

First, the user of the machine translation device 1 inputs the translation object document “ [symbol] (soregakanojonokettenda)” (which means “that is her fault”) to the machine translation device 1 by using an input device such as a keyboard or a mouse. Then, the translation object document accepting portion 11 of the machine translation device 1 accepts the translation object document (Step S101), and passes it to the machine translation portion 14 and the multilingual parallel translation information selecting portion 13. Upon receiving the Japanese translation object document, the multilingual parallel translation information selecting portion 13 performs morphological analysis for the translation object document to divide the document into words. Then, the multilingual parallel translation information including the divided words is selected (Steps S102, S103). Here, it is assumed that the multilingual parallel translation information including the words “ [symbol] (sore)” (which means “that”) and “ [symbol] (ketten)” (which means “fault”) included in the translation object document is selected. The selected multilingual parallel translation information is temporarily stored in a recording medium (not shown).

The machine translation portion 14 performs machine translation from Japanese into English by using the multilingual parallel translation information selected by the multilingual parallel translation information selecting portion 13 (Step S104). Specifically, the machine translation unit 21 machine translates the translation object document “ [symbol] (soregakanojonokettenda)” received from the translation object document accepting portion 11 into the English translation result document “That is her fault.” (Step S201). The translation result document accumulating unit 22 accumulates that English translation result document in a recording medium (not shown) (Step S202).

Further, the translation pair acquisition unit 24 acquires a translation pair by using the selected multilingual parallel translation information, the Japanese translation object document “ [symbol] (soregakanojonokettenda)” received from the translation object document accepting portion 11, and the English translation result document “That is her fault.” accumulated by the translation result document accumulating unit 22 (Step S203).

Specifically, the translation pair acquisition unit 24 identifies the first word “ [symbol] (sore)” of the translation object document (Steps S301, S302), and determines whether the word “ [symbol] (sore)” is included in the selected multilingual parallel translation information (Step S303). For example, the translation pair acquisition unit 24 searches the selected multilingual parallel translation information by using the word “ [symbol] (sore)” as a search key. If the search results in a hit, the translation pair acquisition unit 24 determines that the word is included in the selected multilingual parallel translation information. In this case, the multilingual parallel translation information including the word “ [symbol] (sore)” is selected, and therefore the translation pair acquisition unit 24 determines that the word “ [symbol] (sore)” is included in the selected multilingual parallel translation information, as described above. Then, the translation pair acquisition unit 24 identifies one or more English words corresponding to the word “ [symbol] (sore)”, namely “it” and “that” by using the Japanese-English bilingual dictionary stored in the bilingual dictionary storage unit 23 (Step S304). The translation pair acquisition unit 24 determines whether the first word “it” of the identified English words is included in the English translation result document (Steps S305, S306). For example, the translation pair acquisition unit 24 searches the translation result document by using the word “it” as a search key. If the search results in a hit, the translation pair acquisition unit 24 determines that the word “it” is included in the translation result document. In this case, the word “it” is not included, and therefore the translation pair acquisition unit 24 performs the same processing for the next word “that” (Steps S307, S308, S306). In this case, the word “that” is included in the translation result document, and therefore the translation pair acquisition unit 24 generates a translation pair including the source language word “ [symbol] (sore)” and the target language word “that”, and accumulates the translation pair in a recording medium (not shown) (Step S309). The first record shown in FIG. 10 is a translation pair accumulated in this manner.

Next, the translation pair acquisition unit 24 identifies the second word “ [symbol] (ga)” of the Japanese translation object document (Steps S310, S311, S302), and determines whether the word “ [symbol] (ga)” is included in the selected multilingual parallel translation information (Step S303). It is assumed in this case that the word “ [symbol] (ga)” is not included in the selected multilingual parallel translation information. Then, the translation pair acquisition unit 24 repeats the same processing for the next word (Steps S310, S311, S302). It is assumed that, as a result of such processing being repeatedly performed, the acquisition of translation pairs by using the Japanese translation object document and the English translation result document is completed. It is also assumed that two translation pairs are temporarily stored in a recording medium (not shown) as shown in FIG. 10.

Next, the replacement pair identification unit 25 generates a correct pair by using the selected multilingual parallel translation information and the translation pairs, shown in FIG. 10, that have been acquired by the translation pair acquisition unit 24 (Step S204). Specifically, the replacement pair identification unit 25 determines whether the first translation pair shown in FIG. 10 is included in the selected multilingual parallel translation information (Steps S401, S402). For example, the replacement pair identification unit 25 searches the selected multilingual parallel translation information by using the source language word “ [symbol] (sore)” and the target language word “that” of the first translation pair as a search key, and determines whether a single piece of multilingual parallel translation information including both of these words exists. In this case, it is assumed that such information exists. Then, the replacement pair identification unit 25 accumulates that translation pair as a correct pair in a recording medium (not shown) (Step S405). The first record shown in FIG. 11 is a correct pair accumulated in this manner. Thereafter, the replacement pair identification unit 25 also determines whether the second translation pair is included in the selected multilingual parallel translation information in the same manner (Steps S406, S407, S402). In this case as well, if it is assumed that the second translation pair is included in the multilingual parallel translation information, then the replacement pair identification unit 25 accumulates that translation pair as a correct pair in a recording medium (not shown) (Step S405). Thus, the processing of generating a correct pair ends (Steps S406, S407). FIG. 11 is a table showing correct pairs generated in this manner. For Japanese-English translation, the translation pairs are exactly the same as the correct pairs, as shown in FIGS. 10 and 11.

Next, the replacement pair identification unit 25 performs the processing of identifying a replacement pair by using the translation pairs shown in FIG. 10 and the correct pairs shown in FIG. 11 (Step S205). In this case, all the translation pairs are determined to be included in a set of the correct pairs (Steps S501, S502, S508, S509), and therefore the identification of a replacement pair by the replacement pair identification unit 25 will not be performed. Accordingly, there is no replacement pair in the processing of modifying the translation result document (Step S206) as well, and therefore the word in the translation result document will not be determined to be equal to the replacement object word of the replacement pair, and the modification of the translation result document by the translation result document modification unit 26 will not be performed (Steps S601 to S606, S608, S609). As a result, the English translation result document accumulated by the translation result document accumulating unit 22 will not be modified, and that translation result document itself will be the translation object document in English-German machine translation.

Thereafter, the selection of the multilingual parallel translation information by the multilingual parallel translation information selecting portion 13 is performed again (Steps S105, S106, S103). In this case, the multilingual parallel translation information selecting portion 13 will select the multilingual parallel translation information including the words included in the English translation object document “That is her fault.”. It is assumed that the selected multilingual parallel translation information is as shown in FIG. 12. The selected multilingual parallel translation information is stored in a recording medium (not shown).

Next, the machine translation portion 14 performs machine translation from English into German by using the multilingual parallel translation information selected by the multilingual parallel translation information selecting portion 13 (Step S104). Specifically, the machine translation unit 21 reads the English translation object document “That is her fault.” from the recording medium in which the translation result document accumulating unit 22 has accumulated the translation result document, and machine translates that document into the German translation result document “Das ist ihre Schuld.” (Step S201). The translation result document accumulating unit 22 accumulates that German translation result document in a recording medium (not shown) (Step S202).

The translation pair acquisition unit 24 acquires a translation pair by using the selected multilingual parallel translation information, the English translation object document “That is her fault.”, and the German translation result document “Das ist ihre Schuld.” (Step S203). This processing is the same as previously described, and therefore, the detailed description thereof has been omitted. It is assumed that the two translation pairs shown in FIG. 13 are acquired as a result of this processing of acquiring a translation pair.

Next, the replacement pair identification unit 25 generates a correct pair by using the selected multilingual parallel translation information and the translation pairs, shown in FIG. 13, that have been acquired by the translation pair acquisition unit 24 (Step S204). Specifically, the replacement pair identification unit 25 determines whether the first translation pair shown in FIG. 13 is included in the selected multilingual parallel translation information shown in FIG. 12 (Steps S401, S402). In this case, the aforementioned translation pair is included in the selected multilingual parallel translation information, and therefore the replacement pair identification unit 25 accumulates the translation pair in a recording medium (not shown) as a correct pair (Step S405). The first record shown in FIG. 14 is a correct pair accumulated in this manner. Thereafter, the replacement pair identification unit 25 also determines whether the second translation pair shown in FIG. 13 is included in the selected multilingual parallel translation information in the same manner (Steps S406, S407, S402). In this case, the second translation pair is not included in the selected multilingual parallel translation information shown in FIG. 12, and therefore the replacement pair identification unit 25 identifies a target language (here, German) word included in the selected multilingual parallel translation information including the source language word “fault” included in the translation pair (Step S403). For example, the replacement pair identification unit 25 performs a search in the selected multilingual parallel translation information shown in FIG. 12 by using the source language word “fault” included in the translation pair as a search key, and identifies the multilingual parallel translation information that has been found. Then, the replacement pair identification unit 25 identifies a word in German, which is the target language of the translation pair, that is included in the identified multilingual parallel translation information. In this case, the two German words “Fehler” and “Mangel” are identified. Since two words are identified, the replacement pair identification unit 25 select one of the two words in some way, as described above. Here, it is assumed that “Fehler” is selected. Then, the replacement pair identification unit 25 generates a correct pair including the source language word “fault” included in the translation pair and the selected German word “Fehler”, and accumulates the correct pair in a recording medium (not shown) (Step S404). Then, the processing of generating a correct pair ends (Steps S406,S407). FIG. 14 is a table showing correct pairs generated in this manner.

Next, the replacement pair identification unit 25 performs the processing of identifying a replacement pair by using the translation pairs shown in FIG. 13 and the correct pairs shown in FIG. 14 (Step S205). Specifically, the replacement pair identification unit 25 determines whether the first translation pair shown in FIG. 13 is included in the set of the correct pairs shown in FIG. 14 (Steps S501, S502). In this case, the translation pair (that, das) is included in the set of the correct pairs, and therefore the replacement pair identification unit 25 performs the same determination for the next translation pair (Steps S508, S509, S502). In this case, the translation pair (fault, Schuld) is not included in the set of the correct pairs shown in FIG. 14, and therefore the replacement pair identification unit 25 determines whether the source language word “fault” of the translation pair is the same as the source language word “that” of the first correct pair (Steps S503, S504). In this case, the two words are not the same, and therefore the replacement pair identification unit 25 performs the same determination for the next correct pair (Steps S505, S506, S504). In this case, the source language word “fault” of the translation pair is the same as the source language word “fault” of the second correct pair, and therefore the replacement pair identification unit 25 identifies the replacement pair including a replacement object word that is the target language word “Schuld” of the translation pair and a replacement result word that is the target language word “Fehler” of the second correct pair, and accumulates these words in a recording medium (not shown) (Step S507). Then, the processing of generating a replacement pair ends (Steps S508, S509). FIG. 15 is a table showing a replacement pair generated in this manner.

Next, the translation result document modification unit 26 modifies the translation result document by using the replacement pair, shown in FIG. 15, that has been identified by the replacement pair identification unit 25 and the German translation result document “Das ist ihre Schuld.” accumulated by the translation result document accumulating unit 22 (Step S206). Specifically, the translation result document modification unit 26 identifies the first word “Das” of the German translation result document “Das ist ihre Schuld.” (Steps S601, S602), and determines whether the word matches the replacement object word of the replacement pair (Steps S603, S604). In this case, the two words do not match and there are no other replacement pairs (Steps S605, S606), and therefore the translation result document modification unit 26 also performs the same processing for the next word “ist” (Steps S608, S609, S602 to S604). In this case as well, the word and the replacement object word of the replacement pair do not match and there is no other replacement pair (Steps S605, S606), and therefore the translation result document modification unit 26 also performs the same processing for the next word “ihre” (Steps S608, S609, S602 to S604). In this case as well, the word and the replacement object word of the replacement pair do not match and there is no other replacement pair (Steps S605, S606), and therefore the translation result document modification unit 26 also performs the same processing for the next word “Schuld” (Steps S608, S609, S602 to S604). In this case, the word and the replacement object word of the replacement pair match, and therefore the translation result document modification unit 26 replaces the word “Schuld” by the replacement result word “Fehler” of the replacement pair (Step S607). Since no other word is included in the translation result document, the processing of modifying the translation result document ends (Steps S608, S609). As a result, the modified translation result document that has undergone the modification performed by the translation result document modification unit 26 is “Das ist ihre Fehler.”.

Thereafter, the output portion 15 outputs the German modified translation result document “Das ist ihre Fehler.” (Steps S105 to S107). When the output portion 15 outputs the modified translation result document “Das ist ihre Fehler.”, for example, to a display (not shown), the user is able to know the German translation result corresponding to the input Japanese document “ [symbol] [symbol] (soregakanojonokettenda)” by viewing the indication on the display.

Here, evaluation of the machine translation device 1 according to this embodiment will be described. Machine translation was performed using the machine translation device 1 of this embodiment and a conventional machine translation device, that is, a device that merely repeats machine translation between two languages. As example sentences for evaluation, 100 sentences based on the example sentences for evaluating the performance of machine translation provided by NTT were used. As machine translation, Japanese-German round-trip translation was performed, including four types of translation between two languages, namely, Japanese-English translation, English-German translation, German-English translation, and English-Japanese translation. There were three evaluators, and the evaluation values were based on a 5-point scale.

FIG. 16 is a table for comparing the average evaluation values in the case where the conventional machine translation device was used with the average evaluation values in the case where the machine translation device 1 according to this embodiment was used. In FIG. 16, the case where the machine translation device 1 of this embodiment was used is indicated as “after application”. As can be seen from FIG. 16, for all of the three evaluators, the average evaluation values are increased by using the machine translation device 1 of this embodiment, as compared with the conventional example. The reason for this seems to be that using the machine translation device 1 of this embodiment makes it possible to suppress the occurrence of drift in a translated word, thus achieving a higher accuracy in machine translation.

FIG. 17 is a table showing the proportion of the sentences for which the evaluation value increased, for each of the evaluation values for the conventional example. For example, the evaluation value of an average of 32% of the sentences for which the evaluation value was “3” in the case of using the conventional machine translation device have improved, that is, have increased to 4 or 5 by using the machine translation device 1 of this embodiment. Accordingly, it can be seen that using the machine translation device 1 of this embodiment can contribute to an improvement of the evaluation value of an average of 30% to 60% of the sentences.

As described above, with the machine translation device 1 of this embodiment, it is possible to suppress the occurrence of drift in a translated word by using multilingual parallel translation information when performing translation from a first language through an Nth language by repeating machine translation between two languages. Accordingly, a translation result in the Nth language can be a sentence having the same meaning as the translation object in the first language.

In this embodiment, the case was described where a translation pair is acquired, a correct pair is generated by using the translation pair, and a replacement pair is identified by using the correct pair. However, a replacement pair may be identified without generating a correct pair. For example, when a given translation pair is not included in the selected multilingual parallel translation information, the replacement pair identification unit 25 may use, as a replacement result word, a target language (which is the target language of the translation pair) word included in the selected multilingual parallel translation information including the source language word of the translation pair, and identify a replacement pair whose replacement object word is the source language word of the translation pair. As such, a variety of processing may exist in the processing from the acquisition of the translation pair to the identification of the replacement pair, and there is no limitation with respect to such processing.

In this embodiment, the case was described where the replacement pair identification unit 25 identifies only a single replacement pair even if two or more replacement pairs can be identified. However, the replacement pair identification unit 25 may identify multiple replacement pairs. In that case, the translation result document modification unit 26 may generate a single modified translation result document by using any one of the replacement pairs, or may generate multiple modified translation result documents. In the latter case, the subsequent machine translation or the like will be performed by using each of the modified translation result documents as a translation object document. As a result, multiple modified translation result documents in the Nth language will be eventually generated. Thereafter, the output portion 15 may output all of these documents, or a single document selected from the multiple modified translation result documents in the Nth language. Examples of the method for selecting a single document to be output from the multiple modified translation result documents include a method in which a document with the smallest number of word replacements performed for generating that document is selected. When multiple modified translation documents are handled in this way, the selection by the multilingual parallel translation information selecting portion 13 will be performed for each translation object document, that is, for each modified translation result document. Accordingly, the selected multilingual parallel translation information will be managed for each translation object document.

In this embodiment, the case was described where the machine translation portion 14 includes the machine translation unit 21, the translation result document accumulating unit 22, and the like. However, as described above, the machine translation portion 14 may load selected multilingual parallel translation information and alter the machine translation mechanism itself, thereby performing machine translation using the selected multilingual parallel translation information. In that case, the processing of identifying a replacement pair, modifying a translation result document by using the replacement pair, and the like will not be performed in the machine translation portion 14. In this case, in order to perform the processing of selecting multilingual parallel translation information (the processing of Step S103), it is possible to identify a word pair that is formed by a source language word included in a translation object document in the ith language and a target language word included in a translation result document in the (i+1)th language and that have parallel-translation relation with each other, and select multilingual parallel translation information by using that identified pair, or it is not necessary to perform this. In the former case, the method for identifying the pair may be, for example, a method in which the machine translation portion 14 receives a pair formed by a source language word and a target language word that have been used for machine translation from the machine translation portion 14, or a method similar to the method for acquiring a translation pair. When such a pair is used to select multilingual parallel translation information, the multilingual parallel translation information selecting portion 13 will select the multilingual parallel translation information including both of the two words included in that word pair.

In the above-described embodiment, the case was described where the machine translation device is a stand-alone device. However, the machine translation device may be a stand-alone device, or may be a server device in a server/client system. In the latter case, the accepting of input by the accepting unit and the outputting of a screen by the output unit is performed via a communications line.

In the above-described embodiment, each process or each function may be implemented by centralized processing by a single device or system, or alternatively, may be implemented by distributed processing by multiple devices or systems.

In the above-described embodiment, the information relating to the processing performed by each of the components, such as the information accepted, acquired, selected, generated, transmitted, or received, and the information used by each of the components during processing, such as a threshold value, a numerical formula, or an address may be held temporarily, or for a long period of time in a recording medium (not shown) even if not specified in the description above. Accumulation of the information in the storage medium (not shown) may be performed by each of the components, or by an accumulating portion (not shown). Reading of the information from the storage medium (not shown) may be performed by each of the components, or by a reading portion (not shown).

In the above-described embodiment, when the information used in each of the components and the like, including, for example, a threshold value or an address used in each of the components, and various set values or the like may be altered by the user, the user may or may not be able to alter such information as needed even in a case that has not been specified in the above description. When the user is able to alter such information, such alteration may be realized, for example, by an accepting portion (not shown) that accepts an alteration instruction from the user and an alteration portion (not shown) that alters the information in accordance with such an alteration instruction. Acceptance of such an alteration instruction by the accepting portion (not shown) may be, for example, acceptance from an input device, reception of information transmitted via a communications line, or acceptance of information read from a specific recording medium.

In the above-described embodiment, when two or more components included in the machine translation device include a communication device, an input device, and the like, the two or more components may physically include a single device, or may include separate devices.

In the above-described embodiment, each of the components may be configured with dedicated hardware, or alternatively, components that can be implemented with software may be implemented by executing a program. For example, each of the components may be implemented with a program executing portion such as a CPU reading and executing a software program stored in a recording medium such as a hard disk or a semiconductor memory. The software that implements the machine translation device in the above-described embodiment may be the following program. That is, this program is a program for causing a computer to function as a machine translation device that performs translation from a first language through an Nth language (N is an integer of 3 or more) by repeating machine translation between two languages, the device including: a translation object document accepting portion that accepts a translation object document that is a document in the first language that is to be translated; a multilingual parallel translation information selecting portion that selects, from one or more pieces of multilingual parallel translation information stored in a multilingual parallel translation information storage portion in which are stored one or more pieces of multilingual parallel translation information that are each a set of synonymous words in the first language through the Nth language, the multilingual parallel translation information including a word included in a translation object document in an ith language (i is an integer of 1 to N-1); a machine translation portion that repeats processing of machine translating the translation object document in the ith language into an (i+1)th language until machine translation into the Nth language has been performed, so as to use parallel-translation relation between two languages included in the multilingual parallel translation information selected by the multilingual parallel translation information selecting portion, starting from the translation object document in the first language that has been accepted by the translation object document accepting portion; and an output portion that outputs a document in the Nth language resulting from machine translation performed by the machine translation portion.

In this program, the machine translation portion may include: a machine translation unit that repeats processing of machine translating the translation object document in the ith language into an (i+1)th language, starting from the translation object document in the first language that has been accepted by the translation object document accepting portion; a translation result document accumulating unit that accumulates a translation result document that is a document resulting from machine translation performed by the machine translation unit; a translation pair acquisition unit that acquires a translation pair that is a pair formed by a word included in a translation object document and a word included in a translation result document resulting from machine translating the translation object document by the machine translation unit and that have parallel-translation relation; a replacement pair identification unit that identifies a replacement pair that is a pair formed by a replacement object word that is a word in a target language included in, among translation pairs acquired by the translation pair acquisition unit, a translation pair not included in the multilingual parallel translation information selected by the multilingual parallel translation information selecting portion, and a replacement result word that is a word in the target language included in multilingual parallel translation information that includes a word in a source language included in said translation pair and that has been selected by the multilingual parallel translation information selecting portion; and a translation result document modification unit that generates a modified translation result document that is a document in which, among words included in the translation result document accumulated by the translation result document accumulating unit, the replacement object word included in the replacement pair identified by the replacement pair identification unit has been replaced by the replacement result word included in said replacement pair, the machine translation unit may perform machine translation by using the modified translation result document generated by the translation result document modification unit as the translation object document, and the output portion may output the modified translation result document in the Nth language that has been generated by the translation result document modification unit.

In the above program, the functions implemented with the above program do not include a function that can only be implemented with hardware. For example, at least those functions that can only be implemented with hardware such as a modem or an interface card in the accepting portion that accepts information, the output portion that outputs information, and the like are not included in the functions implemented with the above program.

This program may be executed by downloading from a server or the like, or may be executed by reading a program that has been recorded on a specific recording medium (for example, an optical disk such as a CD-ROM, a magnetic disk, a semiconductor memory, or the like). Further, this program may be incorporated into a product and used on that product, thus forming a program product.

The computer that executes this program may be a single computer or multiple computers. That is, centralized processing or distributed processing may be performed.

FIG. 18 is a schematic diagram showing an example of an appearance of a computer that implements the machine translation device 1 of the above-described embodiment by executing the above program. The above-described embodiment is implemented with computer hardware and a computer program executed on the computer hardware.

In FIG. 18, a computer system 100 includes a computer 101 including a CD-ROM (compact disk read only memory) drive 105 and an FD (flexible disk) drive 106, a keyboard 102, a mouse 103, and a monitor 104.

FIG. 19 is a diagram showing the computer system. In FIG. 19, the computer 101 includes, in addition to the CD-ROM drive 105 and the FD drive 106, a CPU (central processing unit) 111, a ROM (read only memory) 112 for storing a program such as a startup program, a RAM (random access memory) 113 that is connected to the CPU 111 and in which a command of an application program is temporarily stored and a temporary storage area is provided, a hard disk 114 in which an application program, a system program, and data are stored, and a bus 115 that connects the CPU 111, the ROM 112, and the like. The computer 101 may include a network card (not shown) for providing a connection to a LAN.

The program for causing the computer system 100 to execute the functions of the machine translation device 1 according to the above-described embodiment may be stored in a CD-ROM 121 or an FD 122, inserted into the CD-ROM drive 105 or the FD drive 106, and transmitted to the hard disk 114. Alternatively, the program may be transmitted to the computer 101 via a network (not shown) and stored in the hard disk 114. At the time of execution, the program is loaded into the RAM 113. The program may be loaded from the CD-ROM 121 or the FD 122, or directly from a network.

The program does not necessarily have to include, for example, an operating system (OS) or a third party program for causing the computer 101 to execute the functions of the machine translation device 1 according to the above-described embodiment. The program may only include a command portion to call an appropriate function (module) in a controlled mode and obtain desired results. The manner in which the computer system 100 operates is well known, and thus a detailed description thereof has been omitted.

The present invention is not limited to the embodiment set forth herein. It will be appreciated that various modifications are within the scope of the present invention.

### INDUSTRIAL APPLICABILITY

As described above, the machine translation device or the like of the present invention can achieve the effect of suppressing the occurrence of drift in a translated word by using multilingual parallel translation information when translation from a first language through an Nth language (N is an integer of 3 or more) is performed by repeating machine translation between two languages, and therefore is useful as a device that performs machine translation or the like.

### BRIEF DESCRIPTION OF THE DRAWINGS

FIG. 1 is a block diagram showing a configuration of a machine translation device according to Embodiment 1 of the present invention.

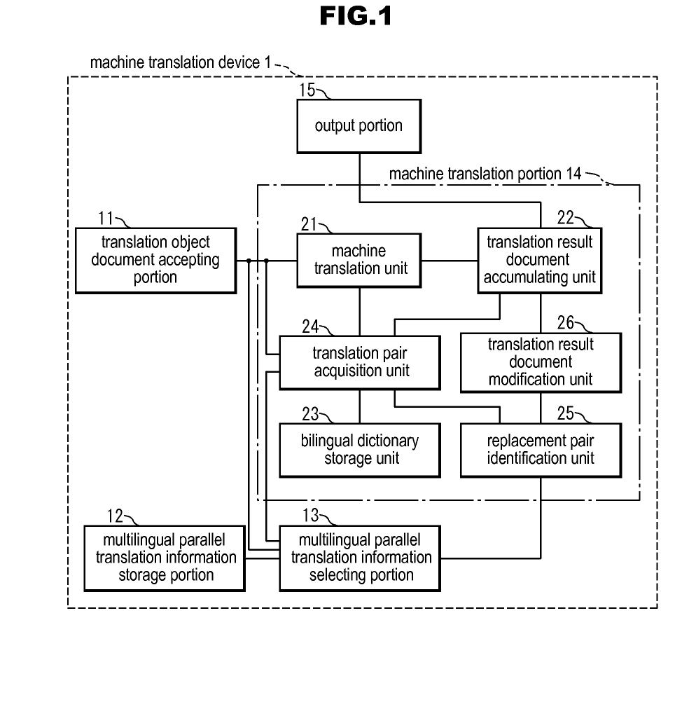

FIG. 2 is a flowchart showing an operation of the machine translation device according to the embodiment.

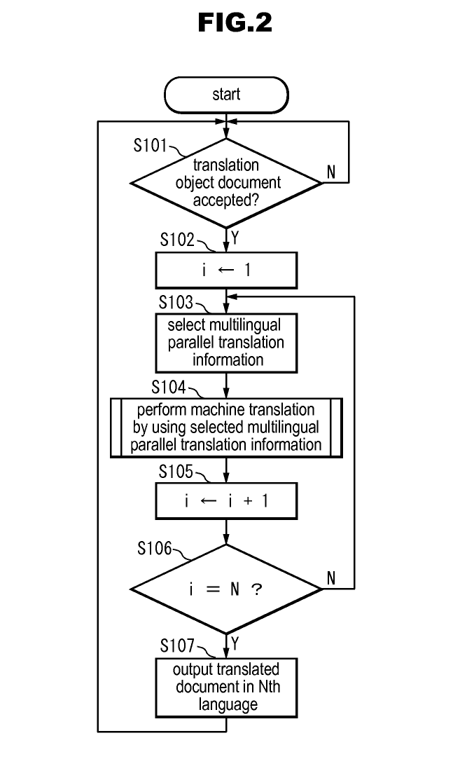

FIG. 3 is a flowchart showing an operation of the machine translation device according to the embodiment.

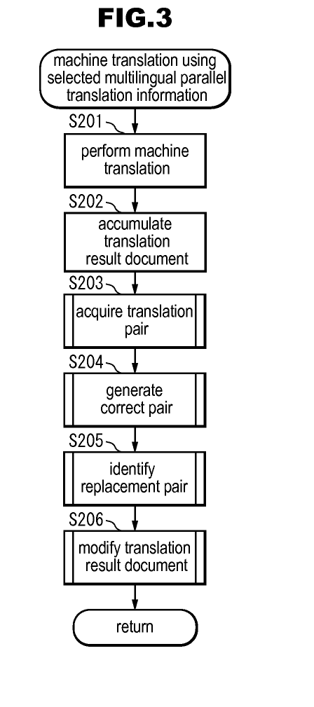

FIG. 4 is a flowchart showing an operation of the machine translation device according to the embodiment.

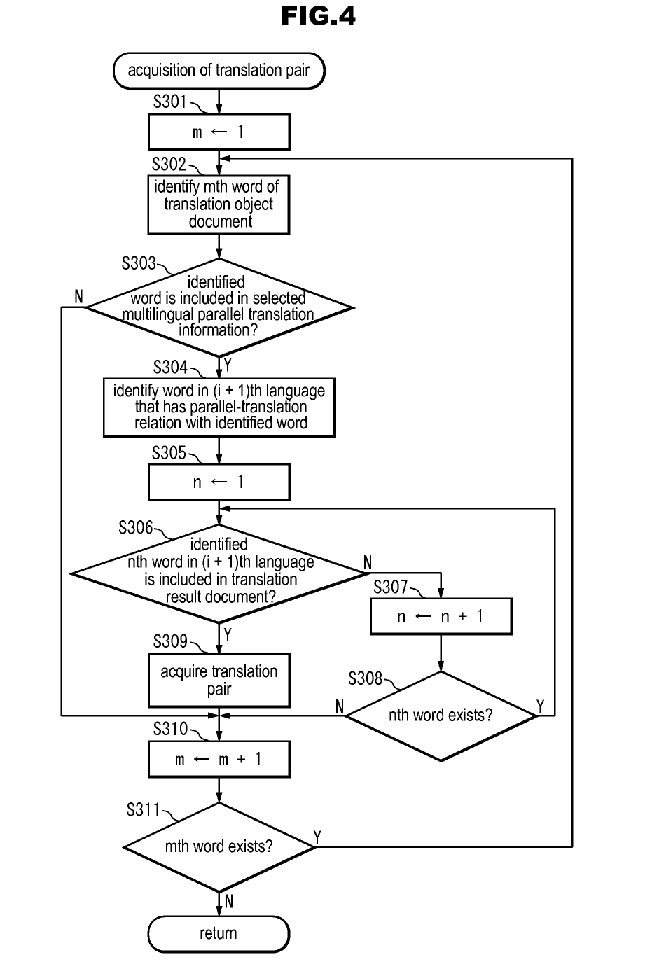

FIG. 5 is a flowchart showing an operation of the machine translation device according to the embodiment.

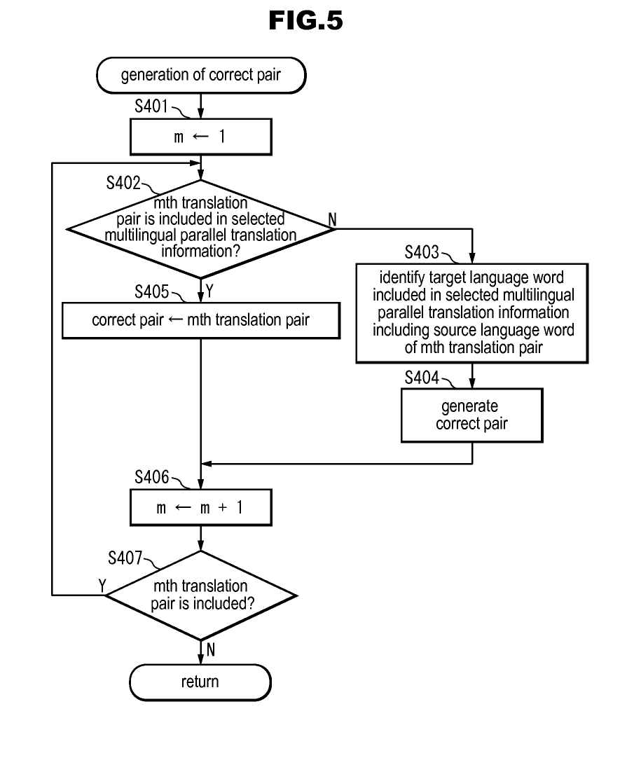

FIG. 6 is a flowchart showing an operation of the machine translation device according to the embodiment.

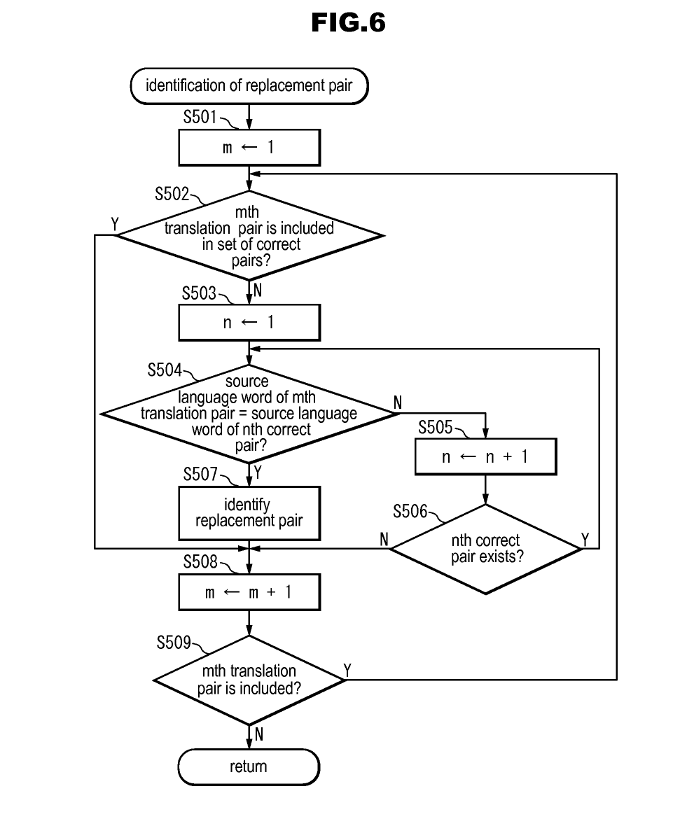

FIG. 7 is a flowchart showing an operation of the machine translation device according to the embodiment.

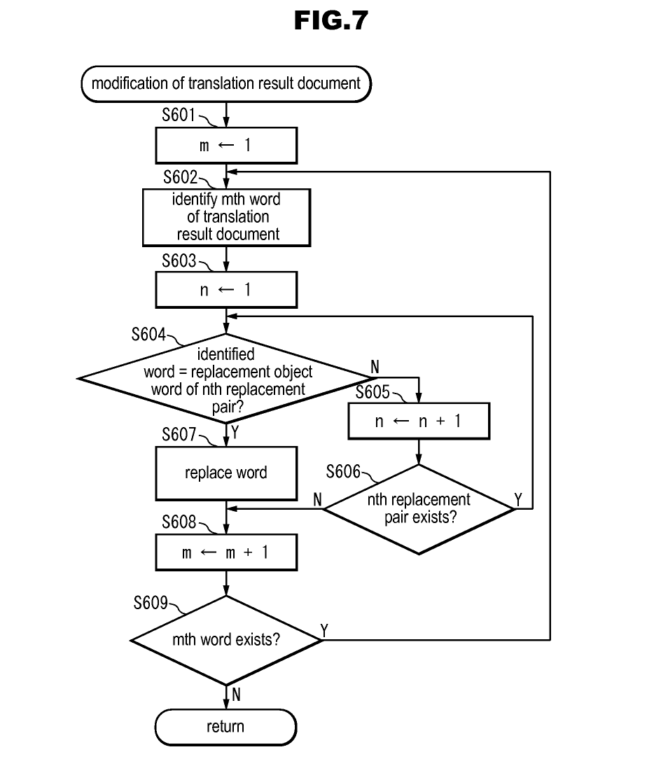

FIG. 8 is a table showing examples of multilingual parallel translation information in the embodiment.

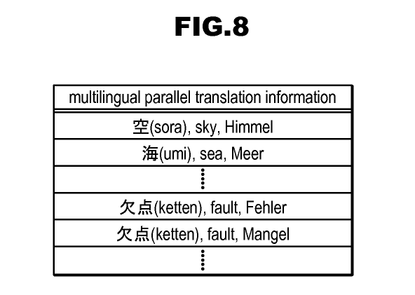

FIG. 9 is a table showing an example of a Japanese-English bilingual dictionary in the embodiment.

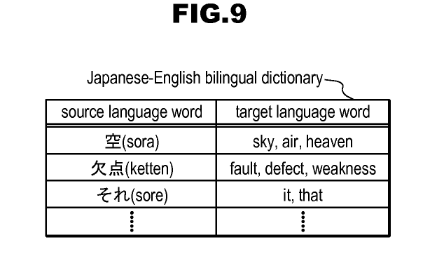

FIG. 10 is a table showing examples of a translation pair in the embodiment.

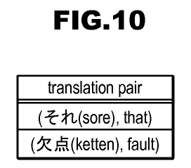

FIG. 11 is a table showing examples of a correct pair in the embodiment.

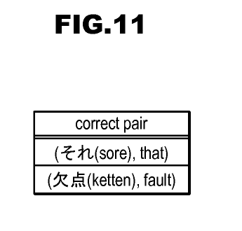

FIG. 12 is a table showing examples of selected multilingual parallel translation information in the embodiment.

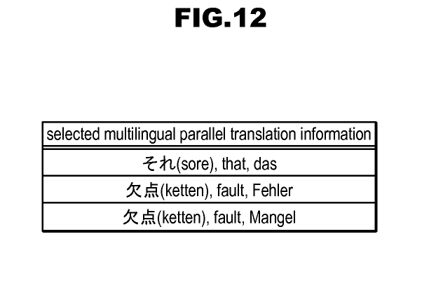

FIG. 13 is a table showing examples of a translation pair in the embodiment.

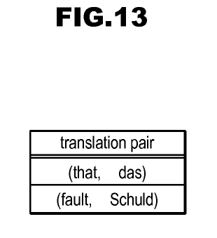

FIG. 14 is a table showing examples of a correct pair in the embodiment.

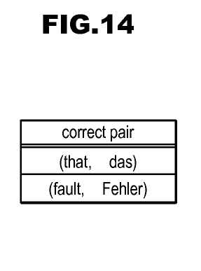

FIG. 15 is a table showing an example of a replacement pair in the embodiment.

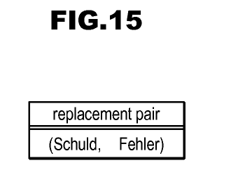

FIG. 16 is a table showing a comparison between evaluation results for the embodiment and those for a conventional example.

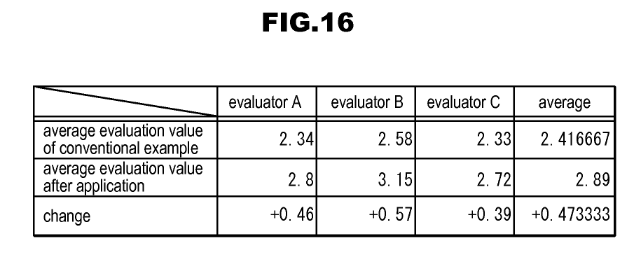

FIG. 17 is a table showing the proportion of improvement of evaluation values in the embodiment.

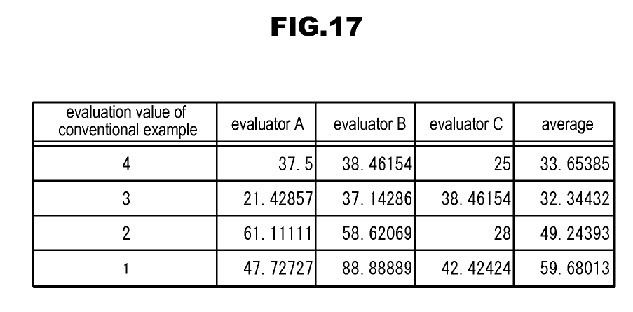

FIG. 18 is a schematic diagram showing an example of an appearance of a computer system in the embodiment.

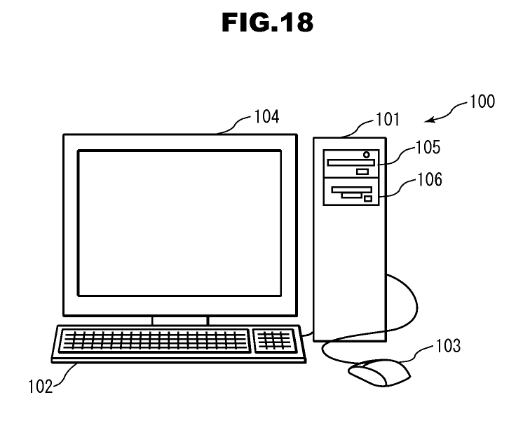

FIG. 19 is a diagram showing an example of a configuration of the computer system in the embodiment.

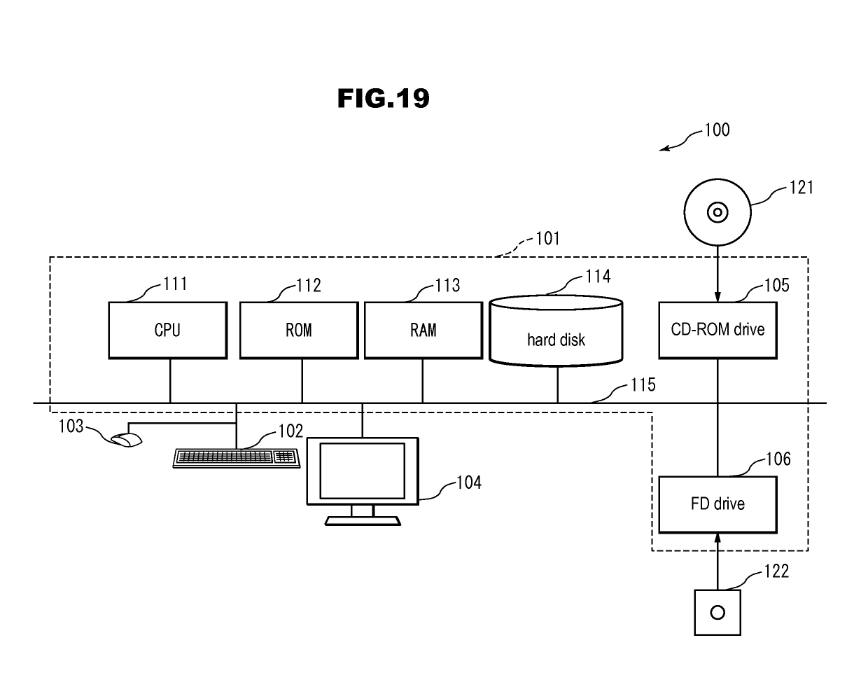

1. A machine translation device that performs translation from a first language through an Nth language (N is an integer of 3 or more) by repeating machine translation between two languages, the device comprising:
a translation object document accepting portion that accepts a translation object document that is a document in the first language that is to be translated;
a multilingual parallel translation information storage portion in which are stored one or more pieces of multilingual parallel translation information that are each a set of synonymous words in the first language through the Nth language;
a multilingual parallel translation information selecting portion that selects the multilingual parallel translation information including a word included in a translation object document in an ith language (i is an integer of 1 to N-1) from the one or more pieces of multilingual parallel translation information stored in the multilingual parallel translation information storage portion;
a machine translation portion that repeats processing of machine translating the translation object document in the ith language into an (i+1)th language until machine translation into the Nth language has been performed, so as to use parallel-translation relation between two languages included in the multilingual parallel translation information selected by the multilingual parallel translation information selecting portion, starting from the translation object document in the first language that has been accepted by the translation object document accepting portion; and
an output portion that outputs a document in the Nth language resulting from machine translation performed by the machine translation portion.

2. The machine translation device according to claim 1,
wherein the machine translation portion comprises:
a machine translation unit that repeats processing of machine translating the translation object document in the ith language into an (i+1)th language, starting from the translation object document in the first language that has been accepted by the translation object document accepting portion;
a translation result document accumulating unit that accumulates a translation result document that is a document resulting from machine translation performed by the machine translation unit;
a translation pair acquisition unit that acquires a translation pair that is a pair formed by a word included in a translation object document and a word included in a translation result document resulting from machine translating the translation object document by the machine translation unit and that have parallel-translation relation;
a replacement pair identification unit that identifies a replacement pair that is a pair formed by a replacement object word that is a word in a target language included in, among translation pairs acquired by the translation pair acquisition unit, a translation pair not included in the multilingual parallel translation information selected by the multilingual parallel translation information selecting portion, and a replacement result word that is a word in the target language included in multilingual parallel translation information that includes a word in a source language included in said translation pair and that has been selected by the multilingual parallel translation information selecting portion; and
a translation result document modification unit that generates a modified translation result document that is a document in which, among words included in the translation result document accumulated by the translation result document accumulating unit, the replacement object word included in the replacement pair identified by the replacement pair identification unit has been replaced by the replacement result word included in said replacement pair,
the machine translation unit performs machine translation by using the modified translation result document generated by the translation result document modification unit as the translation object document, and
the output portion outputs the modified translation result document in the Nth language that has been generated by the translation result document modification unit.

3. The machine translation device according to claim 2,
wherein the machine translation portion further comprises a bilingual dictionary storage unit in which is stored a bilingual dictionary that is information associating a word in the ith language with a word in the (i+1)th language, and
the translation pair acquisition unit acquires the translation pair by using the bilingual dictionary stored in the bilingual dictionary storage unit.

4. The machine translation device according to claim 2,
wherein the translation pair acquisition unit acquires the translation pair from the machine translation unit.

5. The machine translation device according to claim 2,
wherein the translation pair acquisition unit acquires the translation pair whose word in a source language is included in the multilingual parallel translation information selected by the multilingual parallel translation information selecting portion.

6. The machine translation device according to claim 1,
wherein the multilingual parallel translation information selecting portion selects multilingual parallel translation information from the multilingual parallel translation information resulting from the previous selection, each time machine translation between two languages is performed.

7. A machine translation method for performing translation from a first language through an Nth language (N is an integer of 3 or more) by repeating machine translation between two languages by using a translation object document accepting portion, a multilingual parallel translation information storage portion in which are stored one or more pieces of multilingual parallel translation information that are each a set of synonymous words in the first language through the Nth language, a multilingual parallel translation information selecting portion, a machine translation portion, and an output portion, the method comprising:
a translation object document accepting step of accepting, by the translation object document accepting portion, a translation object document that is a document in the first language that is to be translated;
a multilingual parallel translation information selecting step of selecting, by the multilingual parallel translation information selecting portion, the multilingual parallel translation information including a word included in the translation object document in an ith language (i is an integer of 1 to N-1) from the one or more pieces of multilingual parallel translation information stored in the multilingual parallel translation information storage portion;
a first machine translation step of repeating, by the machine translation portion, processing of machine translating the translation object document in the ith language into an (i+1)th language until machine translation into the Nth language has been performed, so as to use parallel-translation relation between two languages included in the multilingual parallel translation information selected in the multilingual parallel translation information selecting step, starting from the translation object document in the first language that has been accepted in the translation object document accepting step; and
an output step of outputting, by the output portion, a document in the Nth language resulting from machine translation performed in the first machine translation step.

8. The machine translation method according to claim 7,
wherein the machine translation portion comprises a machine translation unit, a translation result document accumulating unit, a translation pair acquisition unit, a replacement pair identification unit, and a translation result document modification unit,
the first machine translation step comprises:
a second machine translation step of repeating, by the machine translation unit, processing of machine translating the translation object document in the ith language into an (i+1)th language, starting from the translation object document in the first language that has been accepted in the translation object document accepting step;
a translation result document accumulating step of accumulating, by the translation result document accumulating unit, a translation result document that is a document resulting from machine translation performed in the second machine translation step;
a translation pair acquisition step of acquiring, by the translation pair acquisition unit, a translation pair that is a pair formed by a word included in a translation object document and a word included in a translation result document resulting from machine translating the translation object document in the second machine translation step and that have parallel-translation relation;
a replacement pair identification step of identifying, by the replacement pair identification unit, a replacement pair that is a pair formed by a replacement object word that is a word in a target language included in, among translation pairs acquired in the translation pair acquisition step, a translation pair not included in the multilingual parallel translation information selected in the multilingual parallel translation information selecting step and a replacement result word that is a word in the target language included in multilingual parallel translation information that includes a word in a source language included in said translation pair and that has been selected in the multilingual parallel translation information selecting step; and
a translation result document modification step of generating, by the translation result document modification unit, a modified translation result document that is a document in which, among words included in the translation result document accumulated in the translation result document accumulating step, the replacement object word included in the replacement pair identified in the replacement pair identification step has been replaced by the replacement result word included in said replacement pair,
in the second machine translation step, machine translation is performed by using the modified translation result document generated in the translation result document modification step as the translation object document, and,
in the output step, the modified translation result document in the Nth language that has been generated in the translation result document modification step is output.

9. A computer readable medium having embodied thereon a program, the program being executable by a processor for performing a method for translation from a first language through an Nth language (N is an integer of 3 or more) by repeating machine translation between two languages, the method comprising:
a translation object document accepting step of accepting a translation object document that is a document in the first language that is to be translated;
a multilingual parallel translation information selecting step of selecting, from one or more pieces of multilingual parallel translation information stored in a multilingual parallel translation information storage portion in which are stored one or more pieces of multilingual parallel translation information that are each a set of synonymous words in the first language through the Nth language, the multilingual parallel translation information including a word included in a translation object document in an ith language (i is an integer of 1 to N-1);
a first machine translation step of repeating processing of machine translating the translation object document in the ith language into an (i+1)th language until machine translation into the Nth language has been performed, so as to use parallel-translation relation between two languages included in the multilingual parallel translation information selected in the multilingual parallel translation information selecting step, starting from the translation object document in the first language that has been accepted in the translation object document accepting step; and
an output step of outputting a document in the Nth language resulting from machine translation performed in the first machine translation step.

10. The computer readable medium according to claim 9,
wherein the first machine translation step comprises:
a second machine translation step of repeating processing of machine translating the translation object document in the ith language into an (i+1)th language, starting from the translation object document in the first language that has been accepted in the translation object document accepting step;
a translation result document accumulating step of accumulating a translation result document that is a document resulting from machine translation performed in the second machine translation step;
a translation pair acquisition step of acquiring a translation pair that is a pair formed by a word included in a translation object document and a word included in a translation result document resulting from machine translating the translation object document in the second machine translation step and that have parallel-translation relation;
a replacement pair identification step of identifying a replacement pair that is a pair formed by a replacement object word that is a word in a target language included in, among translation pairs acquired in the translation pair acquisition step, a translation pair not included in the multilingual parallel translation information selected in the multilingual parallel translation information selecting step, and a replacement result word that is a word in the target language included in multilingual parallel translation information that includes a word in a source language included in said translation pair and that has been selected in the multilingual parallel translation information selecting step; and
a translation result document modification step of generating a modified translation result document that is a document in which, among words included in the translation result document accumulated in the translation result document accumulating step, the replacement object word included in the replacement pair identified in the replacement pair identification step has been replaced by the replacement result word included in said replacement pair,
in the second machine translation step, machine translation is performed by using the modified translation result document generated in the translation result document modification step as the translation object document, and
in the output portion step, the modified translation result document in the Nth language that has been generated in the translation result document modification step is output.

11. The machine translation device according claim 3,
wherein the translation pair acquisition unit acquires the translation pair whose word in a source language is included in the multilingual parallel translation information selected by the multilingual parallel translation information selecting portion.

12. The machine translation device according claim 4,
wherein the translation pair acquisition unit acquires the translation pair whose word in a source language is included in the multilingual parallel translation information selected by the multilingual parallel translation information selecting portion.

13. The machine translation device according to claim 11,
wherein the multilingual parallel translation information selecting portion selects multilingual parallel translation information from the multilingual parallel translation information resulting from the previous selection, each time machine translation between two languages is performed.

14. The machine translation device according to claim 12,
wherein the multilingual parallel translation information selecting portion selects multilingual parallel translation information from the multilingual parallel translation information resulting from the previous selection, each time machine translation between two languages is performed.

15. The machine translation device according to claim 2,
wherein the multilingual parallel translation information selecting portion selects multilingual parallel translation information from the multilingual parallel translation information resulting from the previous selection, each time machine translation between two languages is performed.

16. The machine translation device according to claim 3,
wherein the multilingual parallel translation information selecting portion selects multilingual parallel translation information from the multilingual parallel translation information resulting from the previous selection, each time machine translation between two languages is performed.

17. The machine translation device according to claim 4,
wherein the multilingual parallel translation information selecting portion selects multilingual parallel translation information from the multilingual parallel translation information resulting from the previous selection, each time machine translation between two languages is performed.

18. The machine translation device according to claim 5,
wherein the multilingual parallel translation information selecting portion selects multilingual parallel translation information from the multilingual parallel translation information resulting from the previous selection, each time machine translation between two languages is performed.
